(19) United States
(12) Patent Application Publication
(10) Pub. No.: US 2011/0221712 A1
(43) Pub. Date: Sep. 15, 2011

(54) TELESCOPING STYLUS FOR PORTABLE ELECTRONIC DEVICE

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/902,222

(22) Filed: Oct. 12, 2010

(30) Foreign Application Priority Data
Mar. 15, 2010 (CN) 201010124367.6

(51) Int. Cl. G06F 3/033

(52) U.S. Cl. 345/179; 178/19.01

(57) ABSTRACT

A telescoping stylus includes a housing, a nib portion, a stopper member, a first sleeve, a shank member and a second sleeve. The nib portion is attached to one end of the housing. The stopper member is attached to another end of the housing. The shank member is slidably received in the first sleeve. The second sleeve receives the first sleeve and the shank member, and the shank member is fixed to the second sleeve. The second sleeve is releasably positioned in the housing, and abuts the stopper member.

### BACKGROUND

1. Technical Field

The present disclosure relates to styluses, and more particularly to a telescoping stylus for a portable electronic device (e.g., mobile phone).

2. Description of Related Art

Styluses are used as input devices for writing, marking, or pressing on pressure-sensitive screens.

Styluses are usually stored on or in an electronic device, and so are made small. For many people it is difficult to easily and accurately manipulate small styluses, therefore telescoping styluses have come into use. However, some conventional telescoping styluses may be telescoped to be held in many different positions by friction. When the telescoping styluses are used for a period of time, the friction may lessen and the telescoping styluses are not so easily maintained in the different positions. Thus, it is also not suitable or comfortable for everyone. In addition, some telescoping styluses can only be stably operated in a closed state or a fully extended state. This one size fits all type of stylus is not suitable or comfortable for everyone.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present telescoping stylus for portable electronic device. Moreover, in the drawings, like reference numerals designate corresponding parts throughout the several views.

FIG. 1 is an assembled, isometric view of an exemplary telescoping stylus.

FIG. 2 is an exploded, isometric view of the exemplary telescoping stylus.

FIG. 3 is an enlarged, isometric view of a stopper member in FIG. 2 from another aspect.

FIG. 4 is an enlarged, isometric view of a shank member in FIG. 2.

FIG. 5 is a stretched state view of FIG. 1.

FIG. 6 is a partial, cross-sectional view of FIG. 1

FIG. 7 is a cross-sectional view of FIG. 5 taken along line VII-VII.

FIG. 8 is a partial, cut-away view of FIG. 5

### DETAILED DESCRIPTION

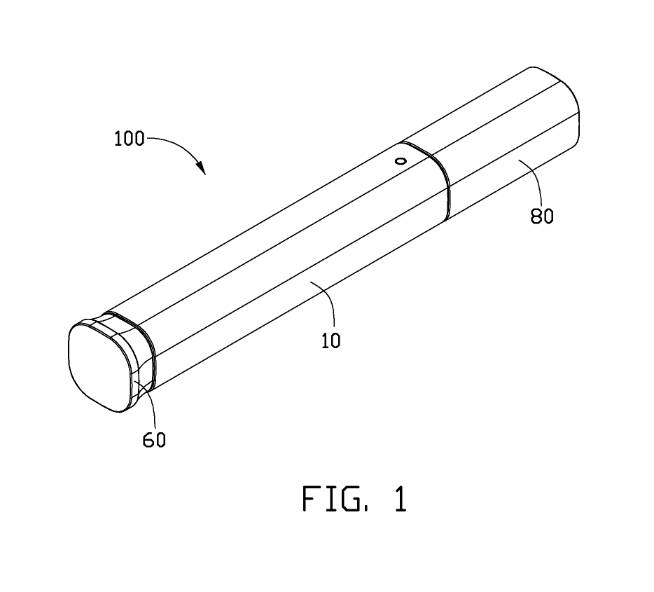

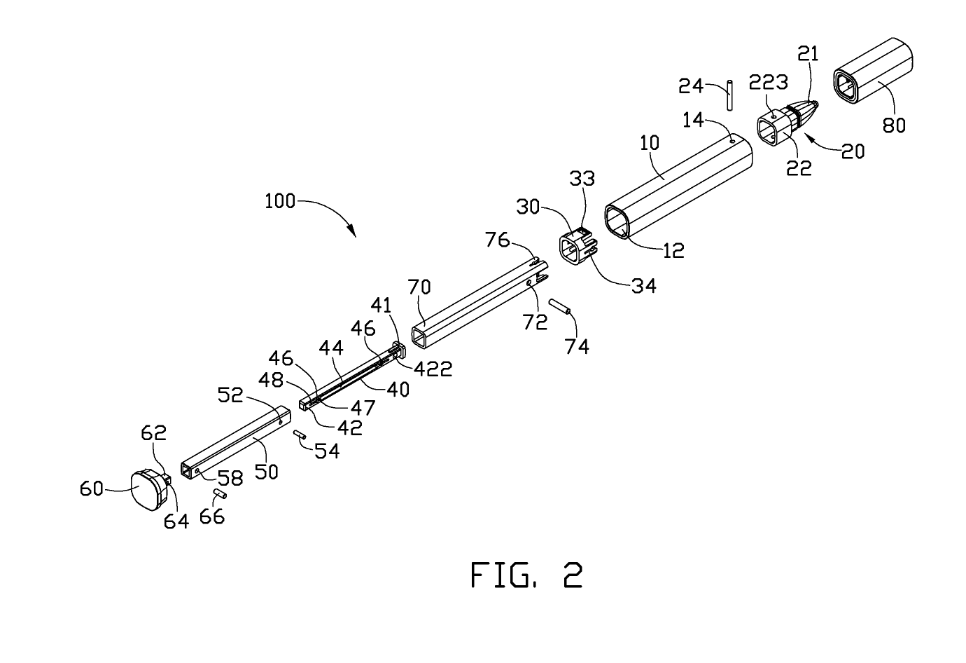

FIGS. 1 and 2 show an exemplary embodiment of a telescoping stylus 100 used with a portable electronic device, such as a mobile phone. The stylus 100 includes a housing 10, a nib portion 20, a stopper member 30, a shank member 40, a first sleeve 50, a head 60, a second sleeve 70, and a cap 80. The nib portion 20 and the stopper member 30 are respectively positioned at two ends of the housing 10. The shank member 40 is slidably received in the first sleeve 50. The first sleeve 50 with the shank member 40 is slidably received in the second sleeve 70. The first sleeve 50 and the second sleeve 70 are received in the housing 10. The head 60 is fixed at one end of the first sleeve 50, and the cap 80 is fitted over the nib portion 20.

The housing 10 is substantially a hollow cylinder, and defines a receiving cavity 12 therein. One end of the housing 10 defines a pin hole 14 in each of two opposite sidewalls.

One end of the nib portion 20 includes a tip portion 21 for contacting a pressure-sensitive screen. A hollow tube portion 22 is formed on the other end of the nib portion 20 opposite to the tip portion 21. One end of the tube portion 22 defines a pin hole 23 in each of two opposite sidewalls. The tube portion 22 can be received in one end of the housing 10, and is fixed to the housing 10. In an exemplary embodiment, the pin hole 14 is aligned with the pin holes 23, and a pin 24 extends through the pin hole 14 and the pin holes 23 to fix the nib portion 20 to the housing 10.

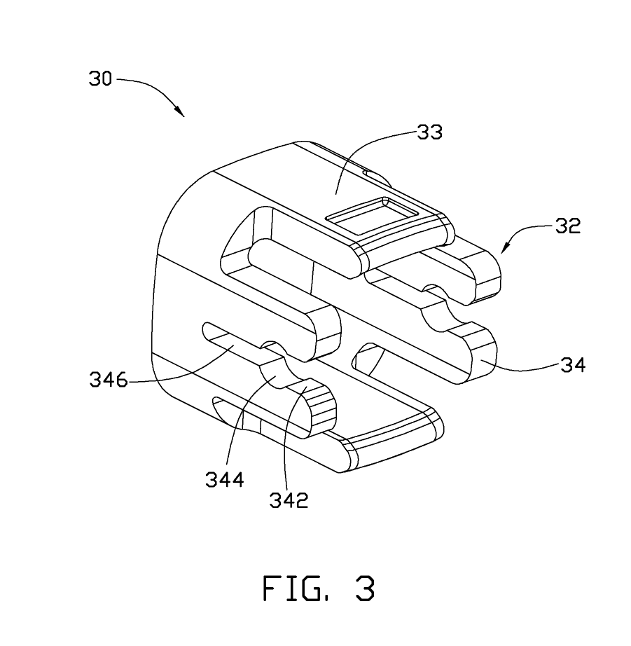

Referring to FIG. 3, the stopper member 30 is received in another end of the housing 10, and is fixed to the housing 10. The stopper member 30 includes two opposite arms 32 and two opposite fixing portions 33. In an exemplary embodiment, the fixing portions 33 are latched to an inner wall of the housing 10 to fix the stopper member 30 to the housing 10. Each arm 32 includes two finger portions 34. An opening 342, a through hole 344, and a cutout 346 are defined between the finger portions 34. The opening 342 is defined at a distal end of the arm 32. The through hole 344 is adjacent to the opening 342. The cutout 346 is recessed from the through hole 344 along an axis of the stopper member 30. The through hole 344 communicates the opening 342 with the cutout 346. The arms 32 have enough elasticity to allow the finger portions 34 to stretch under an outer force.

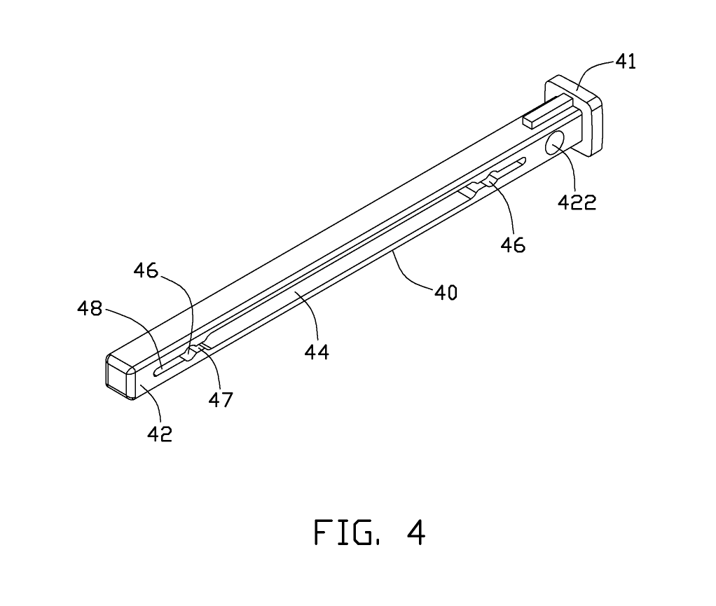

Referring to FIG. 4, the shank member 40 includes a flange portion 41 and a body portion 42. The body portion 42 defines a slot 44 along a longitudinal direction thereof. Each of two ends of the slot 44 orderly defines a slit 47, an aperture 46, and a notch 48. The aperture 46 is larger than the slit 47 and the notch 48. The slit 47 communicates with the slot 44 and the aperture 46. When a pin 54 slides along the slot 44 to the slit 47, the pin 54 can pass through the slit 47 and be received in the aperture 46. The notch 48 helps ensure the slit 47 has enough elasticity to stretch. The body portion 42 defines a latching hole 422 adjacent to the flange portion 41 for fixing the shank member 40 to the second sleeve 70.

The first sleeve 50 is substantially hollow, and defines a pair of holes 52, 58 at each of two ends. The first sleeve 50 has an inside diameter which is large enough to allow it to be fit over the shank member 40. When the shank member 40 is received in the first sleeve 50, the hole 52 of the first sleeve 50 is aligned with the aperture 46. A pin 54 is inserted into the hole 52 and the aperture 46 to slidably attach the shank member 40 to the first sleeve 50.

The head 60 is fixed to one end of the first sleeve 50 as a grasping portion to draw the first sleeve 50 out in a telescoping movement. The head 60 has a disk body with a projection 62 extending therefrom. The projection 62 is fixed to the first sleeve 50. In this embodiment, the projection 62 defines a hole 64. The projection 62 can be inserted in the first sleeve 50, and is aligned with the holes 58. A pin 66 extends through the hole 64, 58 to fix the head 60 to the first sleeve 50.

The second sleeve 70 is substantially hollow, and has an inside diameter which is large enough to allow it to be fit over the shank member 40 and the first sleeve 50. The second sleeve 70 defines a hole 72 and includes two opposite lockable ends 76. When the shank member 40 is received in the second sleeve 70, the latching hole 422 of the shank member 40 is aligned with the hole 72 of the second sleeve 70. A pin 74 is inserted into the latching hole 422 and the hole 72 to fix the shank member 40 to the second sleeve 70. The lockable ends 76 may releasably engage with the pin 24 to allow the second sleeve 70 to be positioned in the housing 10.

The cap 80 may fit over the nib portion 20 for protecting the tip portion 21.

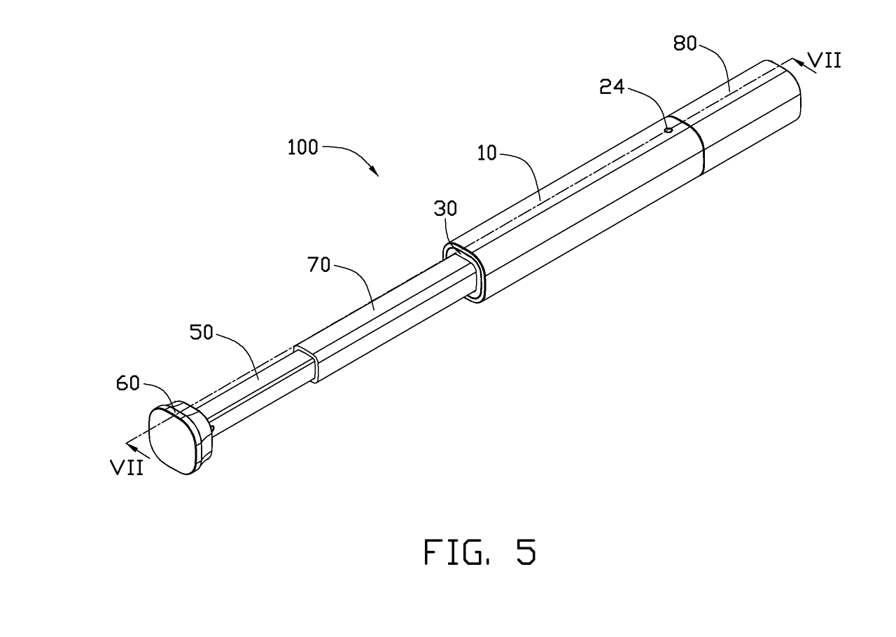

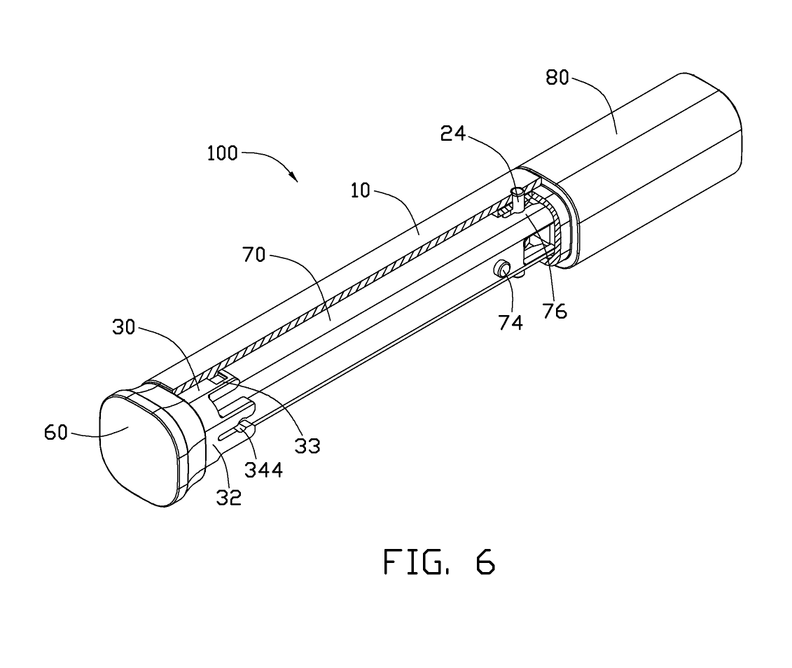

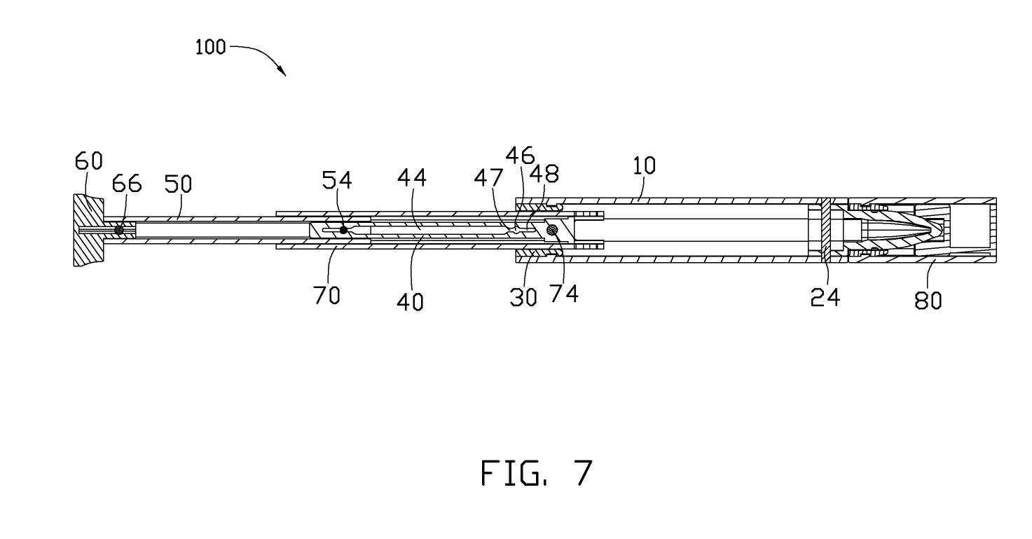

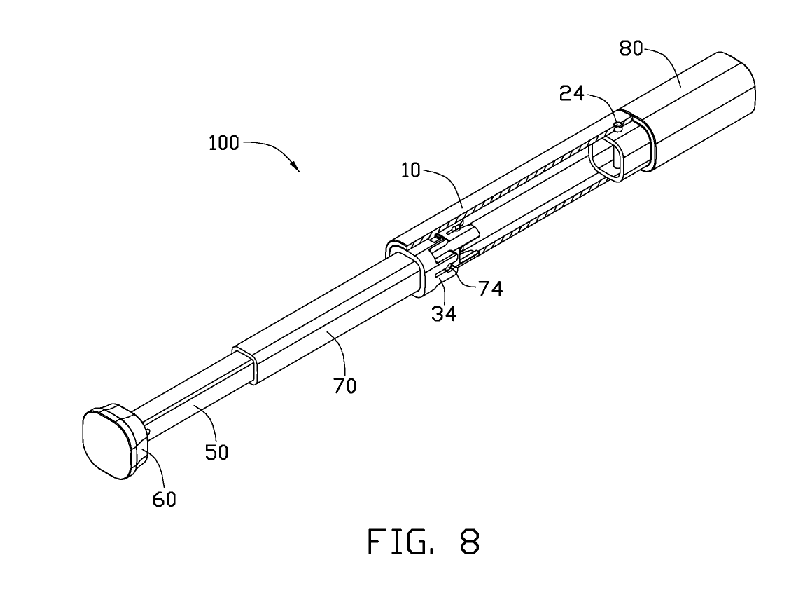

Referring to FIGS. 5-8, when the telescoping stylus 100 is assembled, the nib portion 20 is fixed to the housing 10 by the pin 24 extending through the holes 14, 23. The stopper member 30 is fixed to another end of the housing 10. The shank member 40 is received in the first sleeve 50. The pin 54 extends through the hole 52, the aperture 46 adjacent to the flange 41. The first sleeve 50 with the shank member 40 is received in the second sleeve 70. The latching hole 422 is aligned with the hole 72, and the pin 74 extends through the latching hole 422 and the hole 72 to fix the shank member 40 to the second sleeve 70. After that, the second sleeve 70 with the first sleeve 50 and the shank member 70 is received in the housing 10 through the stopper member 30. The lockable ends 76 are locked to the pin 24. The head 60 is fixed to the first sleeve 50 by the pin 66. The cap 80 is fitted over the nib portion 20. Thus, assembly of the telescoping stylus 100 is finished.

In use, the user may pull the head 60 of the stylus 100. The first sleeve 50 is pulled forcing the pin 54 to move out from the aperture 46 to the slot 44 until the pin 54 is received in the other aperture 46 to realize a first extended state. When the stylus 100 needs a longer length, the head 60 may further be pulled by a force. The shank member 40 forces the second sleeve 70 to separate from the pin 24. The second sleeve 70 moves along the housing 10 until the pin 74 is locked in the arms 32 of the stopper member 30 to realize a second extended state. Thus, the stylus 100 can be easily telescoped to different positions. In addition, the first sleeve 50 can be stably kept in an extended state relative to the shank member 40. The second sleeve 70 can be stably kept in an extended state relative to the housing 10. Thus, the size and operation of the stylus 100 can be personalized for comfort of various users.

It is believed that the present embodiments and their advantages will be understood from the foregoing description, and it will be apparent that different changes may be made thereto without departing from the spirit and scope of the disclosure or sacrificing all of its material advantages, the examples hereinbefore described merely being preferred or exemplary embodiments of the disclosure.

What is claimed is:

1. A telescoping stylus comprising:
a housing;
a nib portion attached to one end of the housing;
a stopper member attached to another end of the housing;
a first sleeve;
a shank member slidably received in the first sleeve; and
a second sleeve receiving the first sleeve and the shank member, the shank member fixed to the second sleeve, the second sleeve releasably positioned in the housing, and abutting the stopper member.

2. The stylus holding mechanism of claim 1, wherein the shank member includes a flange portion and a body portion, the body portion defines a slot along a longitudinal direction thereof, each of two ends of the slot defines an aperture, and a pin is slidably received in the slot, and is locked in the aperture.

3. The stylus holding mechanism of claim 1, wherein the shank member is fixed to the second sleeve by a pin, and the pin is releasably engaged in the stopper member.

4. The stylus holding mechanism of claim 3, wherein the stopper member includes two opposite arms and two opposite fixing portions, the fixing portions are latched to the housing, each arm includes two finger portions for releasably locking the pin.

5. The stylus holding mechanism of claim 4, wherein an opening, a through hole and a cutout are defined between the finger portions, the opening is defined at a distal end of the arm, the through hole is adjacent to the opening, the cutout is recessed from the through hole along an axis of the stopper member, the through hole communicates the opening with the cutout.

6. The stylus holding mechanism of claim 1, wherein the second sleeve includes two opposite lockable ends releasably engagable with a pin to allow the second sleeve to be positioned in the housing.

7. A telescoping stylus comprising:
a housing;
a stopper member attached to the housing;
a first sleeve;
a shank member attached to the first sleeve, the shank member having two positions relative to first sleeve; and
a second sleeve attached to the housing, the shank member fixed to the second sleeve, the shank member, the first sleeve and the second sleeve received in the housing, the second sleeve releasably positioned in the housing, and abutting the stopper member.

8. The stylus holding mechanism of claim 7, wherein the second sleeve includes two opposite lockable ends releasably engagable with a pin to allow the second sleeve to be positioned in the housing.

9. The stylus holding mechanism of claim 7, wherein the shank member includes a flange portion and a body portion, the body portion defines a slot along a longitudinal direction thereof, each of two ends of the slot defines an aperture, and a pin is slidably received in the slot, and is locked in the aperture.

10. The stylus holding mechanism of claim 7, wherein the shank member is fixed to the second sleeve by a pin, and the pin is releasably engaged in the stopper member.

11. The stylus holding mechanism of claim 10, wherein the stopper member includes two opposite arms and two opposite fixing portions, the fixing portions are latched to the housing, each arm includes two finger portions for releasably locking the pin.

12. The stylus holding mechanism of claim 11, wherein an opening, a through hole and a cutout are defined between the finger portions, the opening is defined at a distal end of the arm, the through hole is adjacent to the opening, the cutout is recessed from the through hole along an axis of the stopper member, the through hole communicates the opening with the cutout.
